(19) United States
(12) Patent Application Publication
(10) Pub. No.: US 2022/0324142 A1
(43) Pub. Date: Oct. 13, 2022

(54) METHODS, SYSTEMS AND COMPUTER PROGRAM PRODUCTS FOR PRODUCING RIGID FOAM BOARDS USING OPTICAL AND INFRARED IMAGING

(71) Applicant: Covestro LLC, Pittsburgh, PA (US)

(72) Inventors: Devin W. Ulam, Pittsburgh, PA (US); Steven G. Owens, Sewickley, PA (US); David D. Steppan, Gibsonia, PA (US); Scott M. Cloherty, Canonsburg, PA (US); Thomas N. Thompson, Imperial, PA (US)

(21) Appl. No.: 17/634,284

(22) PCT Filed: Aug. 11, 2020
(86) PCT No.: PCT/US2020/045744

§ 371 Date: Feb. 10, 2022

Related U.S. Application Data
(60) Provisional application No. 62/888,592, filed on Aug. 19, 2019.

(51) Int. Cl. B29C 44/60; B29C 44/14

(52) U.S. Cl. CPC B29C 44/60; B29C 44/14; B29K 2075/00

(57) ABSTRACT

Disclosed are methods, systems and computer program products for producing rigid foam board, comprising: depositing a foam producing mixture on a facer as it travels along a conveyor; producing a rigid foam board via an exothermic reaction; imaging the rigid foam board after it is produced but before it has cooled to room temperature, using an infrared or an optical imaging device, to capture an image of the rigid foam board; receiving a signal comprising the captured image from the imaging device to a computing device; determining, based on the captured image, if a defect that requires correction exists in the rigid foam board; and optionally, in response to determining that a defect requiring correction exists, modifying a process parameter in producing rigid foam board.

### FIELD

The present invention is directed to, among other things, methods, systems and computer program products for producing rigid foam boards using optical and infrared imaging.

### BACKGROUND

Insulation plays an important role in the energy efficiency and environmental impact of building envelopes. Rigid foam boards are used for building insulation as it has many advantages, such as relatively low installed cost, good fire resistance and high thermal resistance. In producing rigid foam boards, it is important to maintain good quality control, so the boards will function as expected. In addition, like many processes, it is important to minimize waste and downtime as producers strive to utilize their assets and raw materials to a more efficient manner.

The raw materials that are used in creating rigid foam boards are fluids that are designed to harden quickly into rigid foam boards. If the process is not operating as designed, the boards may be created with irregular foam density, or have cracks or large bubbles inside the rigid foam, which may act to decrease the insulating quality of the board, across its entire width. While quality control process may identify some boards that have such defects, the boards may have to be sold at a lower price or scrapped entirely. Meanwhile, the process for producing rigid foam boards may have to be shut down to fix whatever caused the quality problem.

It would be desirable to improve the methods of producing rigid foam boards, to reduce the amount of waste or substandard rigid foam boards, to reduce the amount of downtime in fixing processes that produce rigid foam board, and to improve the utilization of raw materials and the assets used to create rigid foam boards.

### SUMMARY OF THE INVENTION

In one embodiment, a method, system or a computer program product for producing a rigid foam board is disclosed, comprising: depositing a foam producing mixture on a facer as it travels along a conveyor; producing the rigid foam board, from the foam producing mixture via an exothermic reaction; imaging the rigid foam board after it is produced but before it has cooled to room temperature, using an infrared or an optical imaging device, to capture an image of the rigid foam board; receiving a first signal comprising the captured image from the imaging device to a computing device; determining, based on the captured image, if a defect that requires correction exists in the rigid foam board; and optionally, in response to determining that a defect requiring correction exists, modifying a process parameter in producing rigid foam board.

In another embodiment, the foam producing mixture comprises an organic polyisocyanate, a polymeric polyol and a blowing agent. In another, the infrared or optical imaging device is an infrared camera.

In still another embodiment, the defect is selected from the group consisting of a knit-line has become too wide, a knit-line is in a different location, a V-hole has appeared, a void has appeared, the predicted foam density is too high, the predicted foam density is too low, the predicted compressive strength is too high, the predicted compressive strength is too low.

In yet another embodiment, the process parameter is selected from the group consisting of flow from an outlet, placement of an outlet, orientation of an outlet, angle of an outlet, notifying a process operator, speed of producing the rigid foam board, speed of a conveyor, components of the foam producing mixture, amounts of a component of the foam producing mixture and halt production.

In another embodiment not yet mentioned, the method, system or computer program product further comprises the steps of: determining the rigid foam board does not meet quality standards, based on the captured image of the rigid foam board; cutting the rigid foam board; and separating the cut rigid foam board that does not meet quality standards.

In a different embodiment, the method, system or computer program product, further comprises the steps of: displaying on a user interface at least one of a process parameter and a visual representation of the captured image; receiving on the user interface an input to change at least one process parameter; and altering the at least one process parameter in response to the input from the user interface.

In another different embodiment, the method, system or computer program product further comprises the steps of: receiving one or more alternative rigid foam board product specifications; determining if, by altering at least one process parameter, the alternative rigid foam board product can be produced according to the product specifications; and altering at least one process parameter to produce the alternative rigid foam board product according to the product specifications.

In yet another embodiment, in response to determining that a defect requiring correction has appeared, modifying a process parameter in producing the rigid foam board, the method, system or computer program product comprises: receiving, with at least one processor, at least one of: (a) data associated with a previously-stored solution to correcting the defect that has appeared in the rigid foam board; or (b) data from a predictive model used to generate a solution to correcting the defect that has appeared in a rigid foam board; and altering at least one process parameter in response to the data received by the at least one processor.

In a different embodiment not yet named, the method, system or computer program product further comprises the steps of: receiving a second signal comprising a captured image from the imaging device to a computing device, after the process parameter has been modified; and storing data associated with the first and second signals, and the modification of the process parameter in producing rigid foam board, to the computing device.

### BRIEF DESCRIPTION OF THE DRAWINGS

FIG. 1 is a depiction of a process to produce rigid foam boards;

FIG. 2 is a top perspective view of a rigid foam board, that meets quality standards;

FIG. 3 is a top perspective view of a rigid foam board, that does not meet quality standards;

FIG. 4 is a schematic view for a process analyzer and controller; and

FIG. 5 is a step diagram for a method for analyzing and controlling a process to make rigid foam board, after a problem has been detected.

### DETAILED DESCRIPTION

Various embodiments are described and illustrated in this specification to provide an overall understanding of the structure, function, properties, and use of the disclosed inventions. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer (e.g., laptop computer or tablet computer), a wearable device (e.g., watches, glasses, lenses), a personal digital assistant (PDA), and/or other like devices. In other non-limiting embodiments, the computing device may be a desktop computer or other non-mobile computer. Furthermore, the term “computer” may refer to any computing device that includes the necessary components to receive, process, and output data, and normally includes a processor, a memory, an input device, and a network interface. While a computer may further include a display, a display is not required for all embodiments. An “interface” refers to a generated display, such as one or more graphical user interfaces (GUIs) with which a user may interact, either directly or indirectly (e.g., through a keyboard, mouse, etc.). Further, one or more computers, e.g., servers, or other computerized devices, directly or indirectly communicating in the network environment may constitute a “system”.

The raw materials used in producing rigid foam boards are fluids: liquids or gases that are sprayed into atmospheric pressure and temperature conditions, where the materials react with each other to produce rigid foam. Such foam producing mixtures are typically prepared such that the entire mixture is deposited together. The foam producing mixture typically comprises an organic polyisocyanate, a polymeric polyol, and a blowing agent.

Any of the known organic polyisocyanates can be used in the practice of the present invention. Examples of suitable polyisocyanates include, without limitation, substituted or unsubstituted aromatic, aliphatic, and cycloaliphatic polyisocyanates having at least two isocyanate groups. Polyfunctional aromatic isocyanates are often used. Specific examples of suitable aromatic isocyanates include, but are not limited to, 4,4′-diphenylmethane diisocyanate (MDI), polymeric MDI (pMDI), toluene diisocyanate, allophanate-modified isocyanates, isocyanate-terminated prepolymers and carbodiimide-modified isocyanates. The organic polyisocyanate may comprise pMDI having an average NCO functionality of from 2.2 to 3.3 and a viscosity of from 25 to 2000 mPas and prepolymers thereof prepared with polyols or other oligomers or polymers such as polyether or polyester polyols that contain active hydrogen atoms. The pMDI may have a functionality of from 2.2 to 3.0 and a viscosity less than about 800 mPas at 25° C. Any mixtures of organic polyisocyanates may, of course, be used.

The organic polyisocyanate(s) is/are included in the foam producing mixture, in an amount of at least 50%, such as from 55% to 75%, or, in some cases, from 59% to 69% by weight, based on total weight of the foam producing mixture.

The polymeric polyol may be any material having at least two reactive groups capable of reacting with an isocyanate group. The polymeric polyol may be an aromatic polyester polyol and/or a polyether polyol, such as those having an average hydroxyl functionality of from 2 to 8, such as 2 to 6, or, in some cases, 2.0 to 2.5, and/or a hydroxyl number of 100 mg KOH/gm to 1000 mgKOH/gm or, in some cases, 200 mgKOH/gm to 500 mgKOH/gm. In certain embodiments, a blend of an aromatic polyester polyol and a polyester and/or polyether polyol that contains renewable content derived from incorporation of regenerable materials, such as fatty acid triglycerides, sugar, or natural glycerin, is used. The polymeric polyol(s) is/are a present in an amount of 10% to 40%, such as 20% to 40%, or, in some cases, 25% to 35% by weight, based on total weight of the foam producing mixture.

The relative amounts of organic polyisocyanate and polymeric polyol(s) used in the foam producing mixture are selected so as to provide the composition with a NCO:OH index of at least 1.8, such as at least 2.0, or, in some cases, 2.0 to 3.0.

As indicated, the mixture used in certain methods of the present invention comprises a blowing agent composition comprising one or more hydrocarbon blowing agents with an atmospheric pressure boiling point of at least 20° C. (68° F.). In certain embodiments, the blowing agent composition comprises a hydrocarbon with an atmospheric pressure boiling point of at least 20° C. (68° F.) and water. As used herein, “hydrocarbon” refers to chemical compounds composed primarily of carbon and hydrogen that may contain heteroatoms such as oxygen, nitrogen, sulfur, or other elements. In certain embodiments, halogenated blowing agents with a global warming potential (“GWP”) ≥25 (100 year) and ozone depletion potential (“ODP”) >0 are not used in the practice of the present invention.

Specific examples of suitable hydrocarbons with an atmospheric pressure boiling point of at least 20° C. (68° F.) include, but are not limited to, n-pentane (atmospheric pressure boiling point of 36.1° C. (96.9° F.)), isopentane (atmospheric pressure boiling point of 27.7° C. (81.9° F.)), cyclopentane (atmospheric pressure boiling point of 49° C. (120.2° F.)), hexane (atmospheric pressure boiling point of 68° C. (154.4° F.)), 2,2-dimethylbutane (atmospheric pressure boiling point of 50° C. (122° F.)), 2-methylpentane (atmospheric pressure boiling point of 60° C. (140° F.)), 1-hexene (atmospheric pressure boiling point of 63° C. (145.4° F.)), 1-pentene (atmospheric pressure boiling point of 30° C. (86° F.)), acetone (atmospheric pressure boiling point of 56° C. (132.8° F.)), acetaldehyde (atmospheric pressure boiling point of 20.2° C. (68.4° F.)), dimethyl carbonate (atmospheric pressure boiling point of 90° C. (194° F.)), methylal (atmospheric pressure boiling point of 42.3° C. (108.1° F.)), ethyl formate (atmospheric pressure boiling point of 54.3° C. (129.7° F.)), methyl acetate (atmospheric pressure boiling point of 56.9° C. (134.4° F.)), and methyl formate (atmospheric pressure boiling point of 31.8° C. (89.2° F.)). As will of course be appreciated, mixtures of two or more of any of the foregoing or unlisted suitable hydrocarbons can be used. In certain embodiments, the hydrocarbons with an atmospheric pressure boiling point of at least 20° C. (68° F.) is n-pentane, isopentane, cyclopentane, methyl formate, and/or methylal.

In certain embodiments, the hydrocarbon with an atmospheric pressure boiling point of at least 20° C. (68° F.) is present in an amount of at least 1% by weight, such as at least 2% by weight, or, in some cases, at least 3% by weight and up to 10% by weight, such as up to 8% by weight, or, in some cases, up to 6% by weight, based on total weight of the foam producing mixture.

In addition to the hydrocarbon blowing agent, some water is often included in the blowing agent composition. As will be appreciated, water reacts with isocyanates to produce carbon dioxide gas as an auxiliary blowing agent. The amount of water included in the foam-forming composition will often range from 0.05% to 1.0% by weight, such as 0.1% to 0.8% by weight, based on total weight of the foam producing mixture.

If desired, it is also possible that the blowing agent composition comprises a hydrocarbon, such as a hydrofluoroolefin, having an atmospheric pressure boiling point of less than 20° C. (68° F.), specific examples of which include, but are not limited to, butane (atmospheric pressure boiling point of −1° C. (30.2° F.)), isobutane (atmospheric pressure boiling point of −11.7° C. (10.9° F.)), butylene (atmospheric pressure boiling point of −6.6° C. (20.1° F.)), isobutylene (atmospheric pressure boiling point of −6.9° C. (19.6° F.)), trans-1-chloro-3,3,3-trifluoropropene (atmospheric pressure boiling point of 19° C. (66.2° F.)), and dimethyl ether (atmospheric pressure boiling point of −24° C. (−11.2° F.)).

In addition, the foam producing mixture may include any of a variety of optional ingredients.

The foam producing mixture may include a flame retardant composition. Suitable flame retardants for use in the foam-forming composition include, without limitation, halogenated, such as brominated flame retardants, such as brominated polyols, and phosphonated flame retardants, such as a halogenated, such as chlorinated, phosphates.

In certain embodiments, the brominated flame retardant comprises a brominated polyether polyol of the general formula (I):

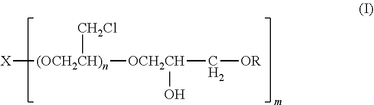

in which n is a number of 0 to 7, m is a number of 2 to 3; Xis a saturated or unsaturated brominated polyol residue; and R is hydrogen or an alkyl group having 1 to 5 carbon atoms. Specific examples of suitable brominated polyether polyols are commercially available as Ixol® B-251 and Ixol® M-125 from Solvay Fluorides LLC, which are believed to be produced using the procedure described U.S. Pat. Nos. 4,020,024, 4,067,911 and 4,072,638. Other suitable brominated flame retardants include, but are not limited to, 3,4,5,6-tetrabromophthalic acid, tribromoneopentyl alcohol, 1,3-propanediol, 2,2-bis(bromomethyl), and pentabromophenyl ether, among others, including mixtures of two or more thereof. Suitable commercially available brominated flame retardants also include those available from ICL Industrial Products as the SaFRon® (6000 Series) brominated flame retardants. Mixtures of two or more of such brominated flame retardants can be used. In certain embodiments, the brominated flame retardant does not contain phosphorous.

Specific examples of suitable phosphorous compounds, such as halogenated phosphates, include, without limitation, tris-(2-chloroethyl)phosphate, tris-(2-chloroisopropyl)phosphate (TCPP), tris(1,3-dichloroisopropyl)phosphate, tris-(2,3-dibromopropyl)phosphate and tetrakis-(2-chloroethyl) ethylene diphosphate, Diethyl Bis-(2-hydroxyethyl)-aminomethylphosphonate, phosphoric acid, triethyl ester, polymer with oxirane and phosphorus oxide (P₂O₅), triethyl phosphate, including mixtures of two or more thereof. Isocyanate-reactive and/or non-reactive non-halogenated phosphorous compounds are often used.

In certain embodiments, the total amount of flame retardant in the foam producing mixture is at least 1% by weight, such as at least 2% by weight and no more than 10% by weight, such as no more than 5% by weight, based on the total weight of the foam producing mixture.

In certain embodiments, the foam producing mixture comprises a surfactant to, for example, stabilize the foaming reaction mixture until it obtains rigidity. Such surfactants often comprise a liquid or solid organosilicon compound, a polyethylene glycol ether of a long chain alcohol, a tertiary amine, an alkanolamine salt of a long chain alkyl acid sulfate ester, an alkylsulfonic ester, or an alkylarylsulfonic acid, or a mixture thereof. Such surfactants are employed in amounts sufficient to stabilize the foaming reaction mixture against collapse and the formation of large and uneven cells. Often, 0.1 to 10% by weight of the surfactant is used, based on the total weight of the foam producing mixture.

In certain embodiments, one or more catalysts are used in the foam producing mixture. Any suitable catalyst may be used including tertiary amines, such as, without limitation, triethylenediamine, N-methylmorpholine, pentamethyl diethylenetriamine, dimethylcyclohexylamine, tetra-methylethylenediamine, 1-methyl-4-dimethylaminoethyl-piperazine, 3-methoxy-N-dimethyl-propylamine, N-ethylmorpholine, diethylethanol-amine, N-cocomorpholine, N,N-dimethyl-N′,N′-dimethylisopropyl-propylene diamine, N,N-diethyl-3-diethyl aminopropylamine and dimethyl-benzyl amine. A catalyst for the trimerization of polyisocyanates, such as an alkali metal alkoxide or carboxylate, or certain tertiary amines, are often employed. Such catalysts are used in an amount which measurably increases the rate of reaction of the polyisocyanate. Typical amounts are 0.1 to 10.0% by weight, based on the total weight of the foam producing mixture.

In certain methods of the present invention, a rigid foam board is prepared from the foam producing mixture. Such rigid foam boards are produced by reacting the organic polyisocyanate and the polymeric polyol in the presence of the blowing agent composition. Any of the known techniques for producing a rigid foam board may be used. As used herein, the term “rigid foam board” refers to a structure comprising a polyisocyanate foam core having two major surfaces, a front and a back, and sides which are typically defined by the walls in which the rigid foam boards are formed. Each end of the board is typically defined where a cuter has sliced through the board to create a desired length. The rigid foam board refers to a foam that meets the compressive strength and flexural strength values listed in Table 1 of ASTM C1289-15.

Processes for producing rigid foam boards from foam producing mixtures are known to those skilled in the art. Examples of suitable processes include: methods for producing polyisocyanurate laminated boardstock insulation, froth-forming method for continuously producing glass fiber reinforced insulation boards in accordance with teachings of U.S. Pat. No. 4,572,865, continuous or discontinuous methods for producing insulated metal panels, and methods for producing molded or free-rise rigid foam articles. Another suitable method is disclosed in U.S. Pat. No. 8,106,106, which is also incorporated herein by reference.

The resulting rigid foam board may have a core foam density of less than 1.80 lb/ft³ (28.8 kg/m³), such as 1.50 to 1.80 lb/ft³ (24.0 to 28.8 kg/m³). Moreover, the thickness of the fully expanded rigid foam board may be from 0.25 to 6 inches (6.35 to 152.4 millimeters), such as 1 to 4 inches (25.4 to 101.6 millimeters), or, in some cases, 1.5 to 3 inches (38.1 to 76.2 millimeters).

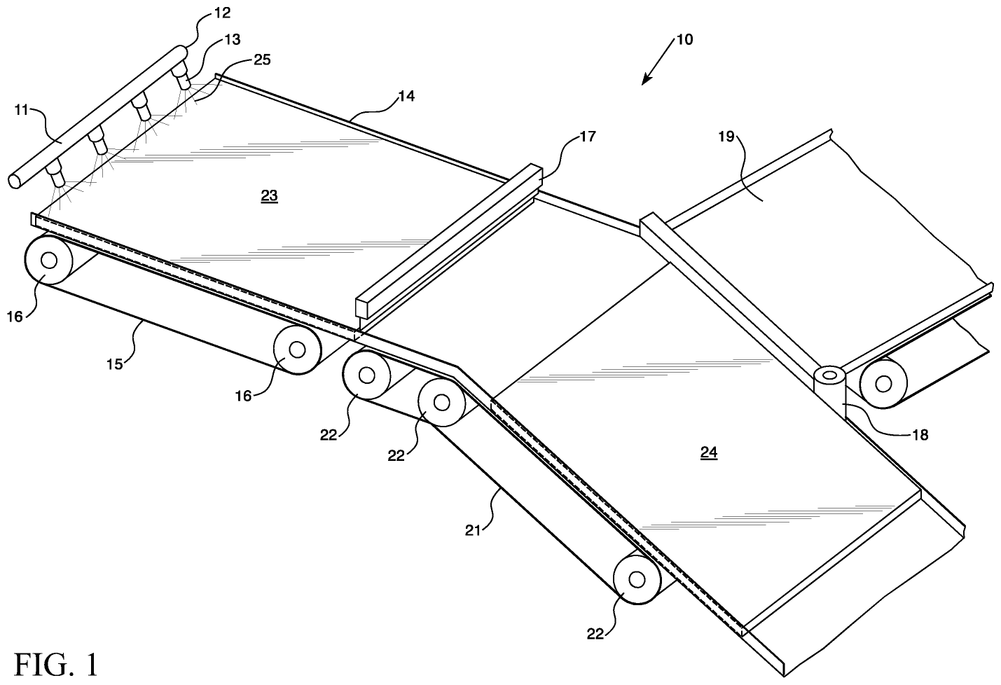

FIG. 1 depicts foam board process 10 in which a foam producing mixture creates rigid foam boards. A foam producing mixture is introduced in header 11, through several control valves 12 and outlets 13. While FIG. 1 shows four (4) outlets, any plurality of outlets may be used, preferably between 2 and 16 outlets. While the term “outlet” is used herein, such outlets may also be one or more of a nozzle, spray nozzle, bore or a pour. Likewise, the term “header” may be a casting rake. The mixture is deposited on a facer as it travels along a conveyor within walls 14. The terms “deposit,” “depositing” and deposited” are used herein; “spraying” and “pouring” may also refer to the same act: depositing a foam producing mixture on a facer. As noted above, the components of the foam producing mixture react under atmospheric conditions, to create rigid foam board 23, as the conveyor moves the foamed mixture after it is sprayed, by use of motorized wheels 16 and belt 15. Cutter 17 will slice rigid foam board 23 into desired lengths, to create the final product, rigid foam board 24. The process may further comprise one or more gates 18 and alternative board areas 19 and 20 to separate rigid foam boards 24 according to product characteristics, such as weight, length or quality. Additional belts 21 and motorized wheels 22 may be used to automatically move and separate rigid foam boards 42. As an alternative to a gate, a robotic arm may also be used to separate the rigid foam board products.

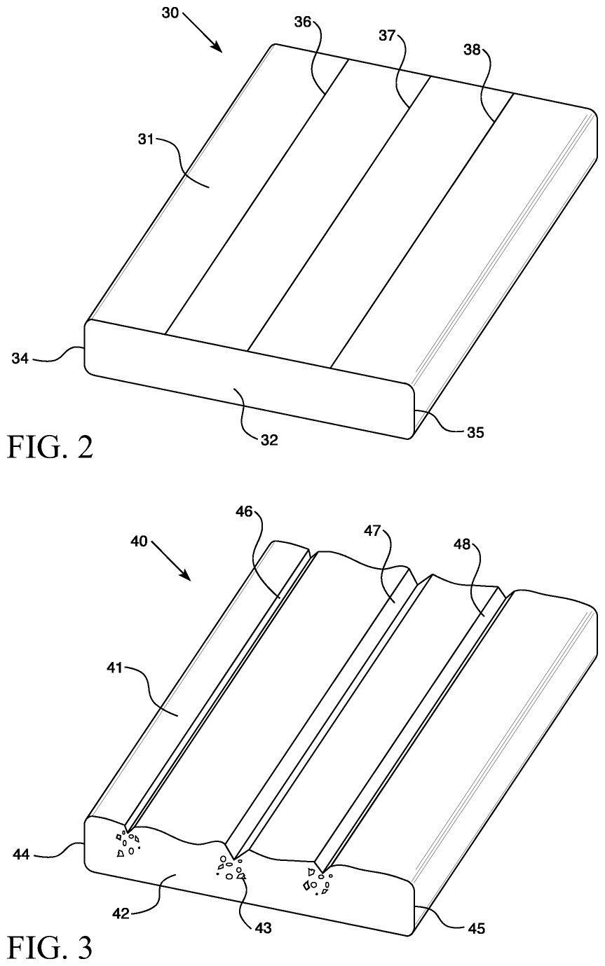

FIG. 2 is a top perspective view of a rigid foam board made by the process shown in FIG. 1. Rigid foam board 30 has a top surface 31, cross section 32, and sides 34 and 35. Rigid foam board 30 also has knit-lines 36, 37 and 38. The knit-lines are formed during formation of the rigid foam board, when the foam producing mixture is deposited from each of the four outlets 13, and the foaming reaction forms the foam which quickly expands into each other, forming the three knit-lines 36, 37 and 38. During normal operating conditions, the amount of foam producing mixture deposited by each outlet 13 is the same, each controlled by their respective control valve 12 as shown in FIG. 1. This will allow the foams to form at the same rate into one single rigid foam board. Knit-lines 36, 37 and 38 may, or may not, be visible to the naked eye. However, as described below, such knit-lines are easily detected by use of an infrared imaging device, such as an infrared camera. Furthermore, the infrared imaging device can detect the width of the knit-line, as well as the position of the knit line on the rigid foam board as well as the distance separating each knit-line.

The reaction of the foam producing mixture to create the rigid foam board is an exothermic one. So the rigid foam will be at an elevated temperature after it is created, before it eventually cools down to room temperature. In addition, the blowing agent composition often acts as an insulator, so it will retain the heat of the reaction even longer after the reaction has completed. An infrared imaging device can detect these differences in temperature that are present in the rigid foam board. Knit-lines, along with outer edges are notably slightly cooler than the rest of the rigid foam board immediately after its production. When viewed by an infrared imaging device, the knit-lines are noticeable, even when the same knit-lines are not noticeable by an optical camera, or the naked eye. Additionally, the IR and optical camera can be used for quality control, and the images can be stored as part of the quality control process demonstrating a rigid foam board was made according to specifications.

Another defect that IR and optical cameras may be able to detect, include differences in foam density and compressive strength. As noted above, IR cameras can detect the presence of voids. IR cameras may likewise be used to detect changes in the foam which may appear as different temperatures, reflecting a different foam density. A warmer rigid foam board may be caused by the presence of more blowing agent and less rigid foam, which also would be a lower foam density. Conversely, a cooler temperature may indicate less blowing agent, and a higher foam density. Compressive strength is another property whose changes may be predicted by changes in temperature as observed by an IR camera. For example, a hotter temperature reading from a rigid foam board may be correlated with low compressive strength, and a cooler temperature reading may be correlated with high compressive strength.

FIG. 3 is a top perspective view of a rigid foam board made by the process shown in FIG. 1, when the process is not operating correctly. Rigid foam board 40 has a top surface 41, cross section 42, and sides 44 and 45. Rigid foam board 40 also has V-holes 46, 47 and 48. The V-holes represent unformed knit-lines; the foam producing mixture did not create sufficient rigid foam in those areas to form a knit-line, and the lack of mixture in that area results in a V-hole from insufficient foaming. Furthermore, the placement and space between the V-holes are not located where the knit-lines are expected. This may result from each of the four outlets 13 not depositing the foam producing mixture at the same rate, so an outlet with a lower flow will result in a V-hole for the resulting foam produced in that area, because there is not enough foam. V-holes may also result from uneven or non-optimal placement of the outlets, so the streams of resulting rigid foam do not merge together to form a proper knit-line. Meanwhile, an adjacent outlet will likely also form a V-hole, as its allotment of foam mixture grows into an area larger than designed, so it may appear there is a problem with that outlet as well, when it may be functioning normally. As shown in FIG. 3, V-hole 46 appears further to the left than it should be, presumably because the outlet that is located furthest to the left is not depositing sufficient foam producing mixture for the allotted area, or because it is not optimally placed. This means the area to the right of V-hole 46 is larger than planned, so the amount of foam producing mixture is insufficient for the larger area, also causing V-holes 46 and 47. Also shown in FIG. 3 are voids 43, which may also result from an insufficient amount of foam producing mixture for the allotted area. So even if rigid foam is produced across the allotted area, the foam close to the knit-lines or V-holes may comprise voids 43. Voids 43 on cross section 42 may sometimes be spotted optically, if they happen to appear where the rigid foam board is cut. More reliably, voids 43 may be detected using an infrared imaging device, where they appear to be slightly warmer than the rest of the rigid foam board.

Such V-holes and voids appear on rigid foam boards when the process is not operating correctly. Specifically, this happens when one or more outlets become(s) clogged by solid material, or the outlets' placement is not optimal. As the foam producing mixture is designed to create a solid as soon as it is released into atmospheric conditions, by expanding and solidifying as it is released into atmospheric conditions, often times this results in solid material sticking to the outlet and hampering its ability to disperse the desired amount of foam producing mixture. Furthermore, because of the system design of each outlet operating in conjunction with the others, when one outlet is not depositing enough mixture, or is not placed correctly, the foam from it does not form a proper knit-line with the material deposited from the adjacent outlet. So the entire board becomes a defect, which must be scrapped. Furthermore, the problem may not be detected right away, so a considerable amount of rigid foam board may have to be scrapped as a result.

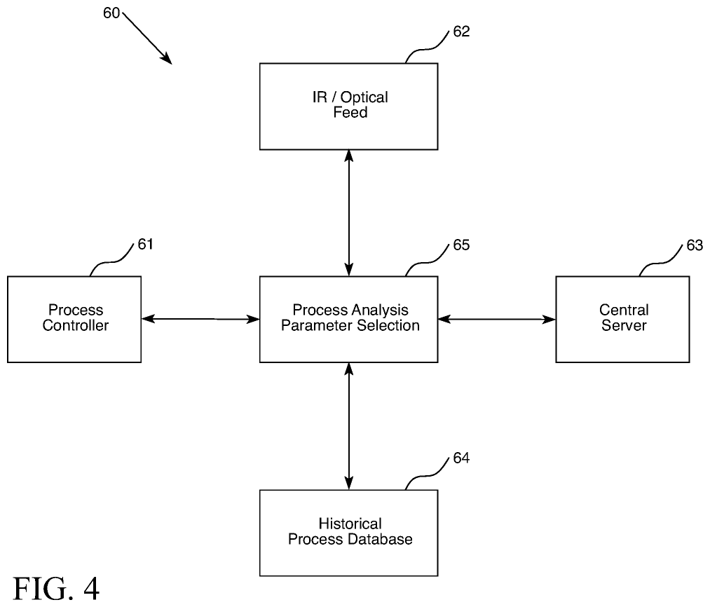

Referring to FIG. 4, a system 60 for analyzing and controlling a process to manufacture rigid foam is shown. The system 60 may include a process controller 61 in communication with a process analysis and parameter selection system 65 in order to provide the process controller with instructions to produce, or to stop producing, rigid foam board, along with the process parameters used to produce rigid foam board. The process parameters may include the flow of foam producing mixture through each of the control valves, the speed of the conveyor belts, and in some embodiments, the placement and orientation of the outlets. The process controller 61 may be a computing device and may include a screen to display on at least one user interface for the user to interact with the process analysis and parameter selection system 65 to view a visible representation of the IR and/or optical IR feeds 62 and/or the process parameters, and control the process for producing the rigid foam board.

The process analysis and parameter selection system 65 may communicate with a central server 63 in order to generate an additional and/or alternative process parameters to produce rigid foam boards, or to suggest to not produce any rigid foam boards, by accessing a list of orders or expected orders, and offering process parameters to produce rigid foam boards to meet such orders. The process analysis and parameter selection system 65 and the central server 63 may be separate systems or may be parts of the same system.

The system 60 preferably comprises infrared (IR) and/or optical feed 62, wherein an infrared camera and/or an optical camera and/or other infrared or optical imaging device send(s) pictures or video of the rigid foam board producing process to the process analysis and parameter selection system 65. Process analysis and parameter selection system 65 comprises data to determine if the images in IR/optical feed show the rigid foam board in normal operation, or if it shows an image of a rigid foam board that is producing off-spec material, or will likely produce off-spec material in the future. Alternatively, such data may be stored or learned, in historical process database 64 as discussed below.

The still or video images provided to process analysis and parameter selection system 65 allow it to determine if there is a problem in the process, such as knit-lines becoming wider into V-holes, or the knit-lines are moving position, as well as any voids that may be seen, and changes in the sizes of voids. As noted above, other defects that may be identified as requiring correction also include foam density and compressive strength. This allows process analysis and parameter selection system 65 to take early action to fix the problem, either before the quality of the rigid foam board is impacted, or at least to minimize the downtime and waste associated with off-spec rigid foam board. Examples of actions it can take include notifying a process operator, either directly or through process controller 61 or central server 63, and/or by sending alternate process parameters to process controller 61. Examples of alternate process parameters include slowing the process down until the outlet can be cleared, by restricting flow through the control valves and slowing down the conveyor. Further alternatives, if the process is so configured, may be to adjust the placement and/or orientation of the outlets to account for the one or more that may not be depositing enough foam producing mixture. In other embodiments, the components of the mixture may be altered, such that the components are added in different amounts or different components are included in the mixture. Such corrective actions may allow for the rigid foam board to be produced in a high quality manner until the clogged outlet(s) may be cleared.

To determine how to alter process parameters in case of changes as seen from the optical and/or IR feeds, process analysis and parameter selection system 65 may communicate with historical process database 64, which may have stored or learned solutions. The solutions comprise data associated with correcting defects identified by IR/optical feed 62, such as knit-lines that has become too wide, or the formation of V-holes or voids, or changes in foam density or compressive strength. Solutions may be learned by artificial intelligence or machine learning, to provide process parameters that may be used to correct for defects that may be seen or predicted by process analysis and parameter selection system 65 and IR/optical feed 62.

The historical process database 64 may include process parameter data associated with a previously-prepared rigid foam board, including the IR/optical feeds and how they may have changed as a result of the process parameter changes. In this way, process analysis and parameter selection system 65 may analyze and consider IR or optical images of similar rigid foam boards, and past actions to correct problems, to create the process parameters to correct the present problem. Historical process database 64 may be loaded with such data and information, and may also learn such data and information as the process experiences problems identified by process analysis and parameter selection system 65 and IR/optical feed 62.

The process analysis and parameter selection system 65 may comprise a predictive model associated with process parameter data along with IR and/or optical images to produce a rigid foam board, from historical process database 64. The predictive models may be generated using interpolations of existing data, database lookups of matches, multiple regression models of effects on altering process parameters in properties of rigid foam boards, including images taken after making such process alterations, or any number of machine learning and neural network algorithms. The predictive model generator may generate methods of correcting problems identified using images from the IR/optical feed, and associated process parameters.

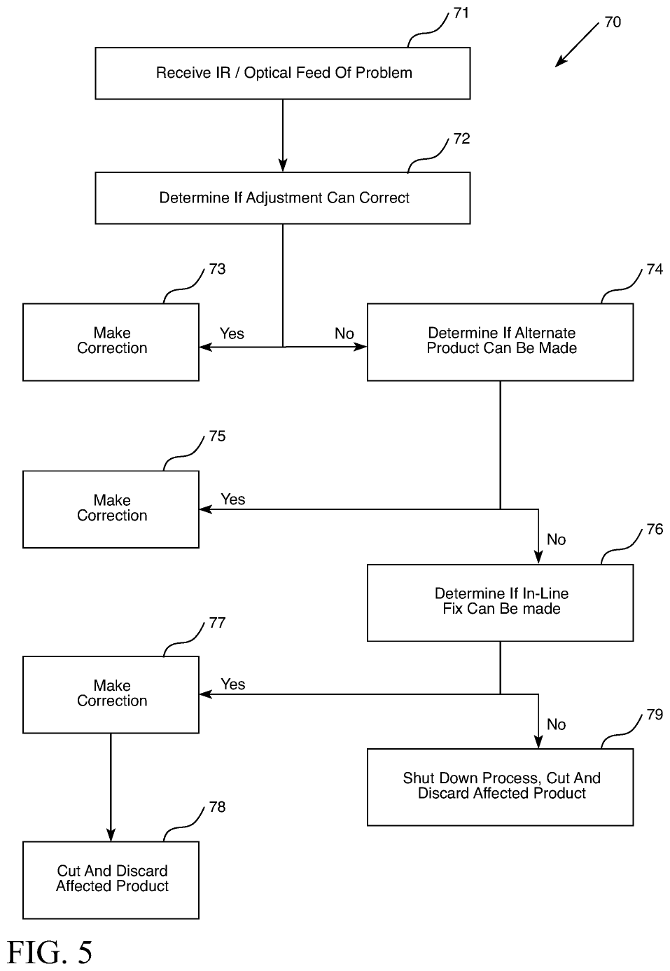

Referring to FIG. 5, a method 70 for rectifying a problem in the production of rigid foam board is shown. In this method, the process analysis and parameter selection system receives an IR/optical feed showing there is a problem 71 in the production process for making rigid foam board. The problem may be of a nature such that product defects such as V-holes or large voids are being produced in the rigid foam board, and are detected by the IR/optical feed. Or the problem may be that the location of the knit-lines appears to have moved. Or the problem may be that the foam density or compressive strength has changed. The process analysis and parameter selection system may also consider a trend showing a change in the images, which would indicate a problem will likely occur in the future.

The system then makes a determination 72 if an adjustment can correct the problem. To make this determination, the system may consider its historical process database, as well as a central server showing alternative products that may be made. From data in the system and/or in the historical process database, the system may consider previous or pre-loaded process changes and the resulting images from changes made to process parameters that were implemented to the system, or were pre-loaded to the system. If a change can be made, then the system directs the process controller to make a correction 73.

If a change cannot be made to correct the problem, then the system determines 74 if an alternate product can be made. In determining if an alternate product can be made, the system may communicate with a central server to review if there are other orders for rigid foam board, as well as the relative value of those orders, to determine if the most desirable course of action would be to change the process parameters to make the alternative product. An example of an alternative product is an order for a lower quality product, or a product that can be made with the present process impairment, as determined by an analysis of the IR/optical feed. If there is such a process change that can be made, the system makes the correction 75 to begin producing the new product.

In another non-limiting embodiment, the system may determine if an alternative product can be made, before determining if an adjustment can correct the defect. In this embodiment, the rigid foam board having a defect, but the board is still within the product specifications of the alternative product, is separated so it may be sold as an alternative product. In addition, the system may predict certain performance characteristics of the rigid foam board, based on the optical and/or IR camera inputs as described herein. The system may grade different products that are made by the process, or the same product having different degrees of defects, and separate the rigid foam board products according to such differences. Furthermore, a performance rating system may be used based on the type and amount of defects observed, or based on the predicted performance of such rigid foam board products. The system would than sort the different board products according to the performance rating system.

If there is no such opportunity to produce an alternative product, then the system determines if an in-line fix can be made to correct the problem. Examples of an in-line fix include changing the flow of one or more control valves to alter the amount of foam producing mixture coming out of each valve, slowing one or more conveyors, changing the position, orientation or angle of one or more of the outlets, and alerting an operator to clear solids from a particular outlet. If the correction can be made, the system then proceeds to make the correction 77, and cut and discard affected product 78. In the case of alerting a system operator, the correction may be to slow production to a minimum, to minimize product that would have to be discarded, and wait until the IR/optical feed shows an improved rigid foam board being produced, such as after the operator has cleared the blocked outlet, and then the system would resume normal operation. As an alternative to discarding the affected product, it may be separated and used as a different grade product, if it should meet the specifications of the alternative grade.

If an in-line fix cannot be made to the process, then the system shuts the process down, alerts the operator, and cuts and discards any affected product 79. As mentioned above, such product may be separated and used as a different grade product.

In a further non-limiting embodiment, a computer program product for creating process parameters for producing rigid foam boards includes at least one non-transitory computer readable medium including program instructions that, when executed by at least one processor, cause the at least one processor to execute any of the systems and methods described herein. The at least one processor may include the process analysis and parameter selection system 65 and/or the historical process database 64.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserve the right to amend the claims during prosecution to add features as variously described in this specification, and such amendments comply with the requirements of 35 U.S.C. § 112, first paragraph, and 35 U.S.C. § 132(a).

In addition, the following aspects are disclosed:
1. A method, system or a computer program product for producing a rigid foam board, comprising:

depositing a foam producing mixture on a facer as it travels along a conveyor;

producing the rigid foam board, from the foam producing mixture via an exothermic reaction;

imaging the rigid foam board after it is produced but before it has cooled to room temperature, using an infrared or an optical imaging device, to capture an image of the rigid foam board;

receiving a first signal comprising the captured image from the imaging device to a computing device;

determining, based on the captured image, if a defect that requires correction exists in the rigid foam board; and

optionally, in response to determining that a defect requiring correction exists, modifying a process parameter in producing rigid foam board.
2. The method, system or computer program product of 1, wherein the foam producing mixture comprises an organic polyisocyanate, a polymeric polyol and a blowing agent.
3. The method, system or computer program product of 1 or 2, wherein the infrared or optical imaging device is an infrared camera.
4. The method, system or computer program product of any of the preceding aspects, wherein the defect is selected from the group consisting of a knit-line has become too wide, a knit-line is in a different location, a V-hole has appeared, a void has appeared, the predicted foam density is too high, the predicted foam density is too low, the predicted compressive strength is too high, the predicted compressive strength is too low.
5. The method, system or computer program product of any of the preceding aspects, wherein the process parameter is selected from the group consisting of flow from an outlet, placement of an outlet, orientation of an outlet, angle of an outlet, notifying a process operator, speed of producing the rigid foam board, speed of a conveyor, components of the foam producing mixture, amounts of a component of the foam producing mixture and halt production.
6. The method, system or computer program product of any of the preceding aspects, further comprising the steps of:

determining the rigid foam board does not meet quality standards, based on the captured image of the rigid foam board;

cutting the rigid foam board; and

separating the cut rigid foam board that does not meet quality standards.
7. The method, system or computer program product of any of the preceding aspects, further comprising the steps of:

displaying on a user interface at least one of a process parameter and a visual representation of the captured image;

receiving on the user interface an input to change at least one process parameter; and altering the at least one process parameter in response to the input from the user interface.
8. The method, system or computer program product of any of the preceding aspects, further comprising the steps of:

receiving one or more alternative rigid foam board product specifications;

determining if, by altering at least one process parameter, the alternative rigid foam board product can be produced according to the product specifications; and

altering at least one process parameter to produce the alternative rigid foam board product according to the product specifications.
9. The method, system or computer program product of any of the preceding aspects, wherein in response to determining that a defect requiring correction has appeared, modifying a process parameter in producing the rigid foam board, comprises:

receiving, with at least one processor, at least one of: (a) data associated with a previously-stored solution to correcting the defect that has appeared in the rigid foam board; or (b) data from a predictive model used to generate a solution to correcting the defect that has appeared in a rigid foam board; and

altering at least one process parameter in response to the data received by the at least one processor.
10. The method, system or computer program product of any of the preceding aspects, further comprising the steps of:

receiving a second signal comprising a captured image from the imaging device to a computing device, after the process parameter has been modified; and

storing data associated with the first and second signals, and the modification of the process parameter in producing rigid foam board, to the computing device.

1. A method for producing a rigid foam board, comprising:
depositing a foam producing mixture on a facer as it travels along a conveyor;
producing the rigid foam board, from the foam producing mixture via an exothermic reaction;
imaging the rigid foam board after it is produced but before it has cooled to room temperature, using an infrared or an optical imaging device, to capture an image of the rigid foam board;
receiving a first signal comprising the captured image from the imaging device to a computing device;
determining, based on the captured image, if a defect that requires correction exists in the rigid foam board; and
optionally, in response to determining that a defect requiring correction exists, modifying a process parameter in producing rigid foam board.

2. The method of claim 1, wherein the foam producing mixture comprises an organic polyisocyanate, a polymeric polyol and a blowing agent.

3. The method of claim 1, wherein the infrared or optical imaging device is an infrared camera.

4. The method of claim 1, wherein the defect is selected from the group consisting of a knit-line has become too wide, a knit-line is in a different location, a V-hole has appeared, a void has appeared, the predicted foam density is too high, the predicted foam density is too low, the predicted compressive strength is too high, the predicted compressive strength is too low.

5. The method of claim 1, wherein the process parameter is selected from the group consisting of flow from an outlet, placement of an outlet, orientation of an outlet, angle of an outlet, notifying a process operator, speed of producing the rigid foam board, speed of a conveyor, components of the foam producing mixture, amounts of a component of the foam producing mixture and halt production.

6. The method of claim 1, further comprising the steps of:
determining the rigid foam board does not meet quality standards, based on the captured image of the rigid foam board;
cutting the rigid foam board; and
separating the cut rigid foam board that does not meet quality standards.

7. The method of claim 1, further comprising the steps of:
displaying on a user interface at least one of a process parameter and a visual representation of the captured image;
receiving on the user interface an input to change at least one process parameter; and
altering the at least one process parameter in response to the input from the user interface.

8. The method of claim 1, further comprising the steps of:
receiving one or more alternative rigid foam board product specifications;
determining if, by altering at least one process parameter, the alternative rigid foam board product can be produced according to the product specifications; and
altering at least one process parameter to produce the alternative rigid foam board product according to the product specifications.

9. The method of claim 1, wherein in response to determining that a defect requiring correction has appeared, modifying a process parameter in producing the rigid foam board, comprises:
receiving, with at least one processor, at least one of: (a) data associated with a previously-stored solution to correcting the defect that has appeared in the rigid foam board; or (b) data from a predictive model used to generate a solution to correcting the defect that has appeared in a rigid foam board; and
altering at least one process parameter in response to the data received by the at least one processor.

10. The method of claim 1, further comprising the steps of:
receiving a second signal comprising a captured image from the imaging device to a computing device, after the process parameter has been modified; and
storing data associated with the first and second signals, and the modification of the process parameter in producing rigid foam board, to the computing device.

11. A system for producing rigid foam board, the system comprising:
depositing a foam producing mixture on a facer as it travels along a conveyor;
producing the rigid foam board, from the foam producing mixture via an exothermic reaction;
imaging the rigid foam board after it is produced but before it has cooled to room temperature, using an infrared or an optical imaging device, to capture an image of the rigid foam board;
receiving a first signal comprising the captured image from the imaging device to a computing device;
determining, based on the captured image, if a defect that requires correction exists in the rigid foam board; and
optionally, in response to determining that a defect requiring correction exists, modifying a process parameter in producing rigid foam board.

12. The system of claim 11, wherein the foam producing mixture comprises an organic polyisocyanate, a polymeric polyol and a blowing agent.

13. The system of claim 11, wherein the infrared or optical imaging device is an infrared camera.

14. The system of claim 11, wherein the defect is selected from the group consisting of a knit-line has become too wide, a knit-line is in a different location, a V-hole has appeared, a void has appeared, the predicted foam density is too high, the predicted foam density is too low, the predicted compressive strength is too high, the predicted compressive strength is too low.

15. The system of claim 11, wherein the process parameter is selected from the group consisting of flow from an outlet, placement of an outlet, orientation of an outlet, angle of an outlet, notifying a process operator, speed of producing the rigid foam board, speed of a conveyor, components of the foam producing mixture, amounts of a component of the foam producing mixture and halt production.

16. The system of claim 11, further comprising the steps of:
determining the rigid foam board does not meet quality standards, based on the captured image of the rigid foam board;
cutting the rigid foam board; and
separating the cut rigid foam board that does not meet quality standards.

17. The system of claim 11, further comprising the steps of:
displaying on a user interface at least one of a process parameter and a visual representation of the captured image;
receiving on the user interface an input to change at least one process parameter; and
altering the at least one process parameter in response to the input from the user interface.

18. The system of claim 11, further comprising the steps of:
receiving one or more alternative rigid foam board product specifications;
determining if, by altering at least one process parameter, the alternative rigid foam board product can be produced according to the product specifications; and
altering at least one process parameter to produce the alternative rigid foam board product according to the product specifications.

19. The system of claim 11, wherein in response to determining that a defect requiring correction has appeared, modifying a process parameter in producing the rigid foam board, comprises:
receiving, with at least one processor, at least one of: (a) data associated with a previously-stored solution to correcting the defect that has appeared in the rigid foam board; or (b) data from a predictive model used to generate a solution to correcting the defect that has appeared in a rigid foam board; and
altering at least one process parameter in response to the data received by the at least one processor.

20. The system of claim 11, further comprising the steps of:
receiving a second signal comprising a captured image from the imaging device to a computing device, after the process parameter has been modified; and
storing data associated with the first and second signals, and the modification of the process parameter in producing rigid foam board, to the computing device.

21.-30. (canceled)
